(19) United States
(12) Patent Application Publication
(10) Pub. No.: US 2026/0304531 A1
(43) Pub. Date: Oct. 1, 2026

(54) METHOD AND DEVICE RELATED TO TRANSMISSION OPERATION OF REPEATER CONTROLLED BY NETWORK IN NEXT-GENERATION MOBILE COMMUNICATION SYSTEM

(71) Applicant: Samsung Electronics Co., Ltd., Suwon-si, Gyeonggi-do (KR)

(72) Inventor: June HWANG, Suwon-si (KR)

(21) Appl. No.: 19/472,589

(22) PCT Filed: Mar. 21, 2024
(86) PCT No.: PCT/KR2024/095611

§ 371 Date: Oct. 3, 2025

(30) Foreign Application Priority Data
Apr. 6, 2023 (KR) 10-2023-0045613
May 11, 2023 (KR) 10-2023-0061033

(51) Int. Cl. H04W 76/19; H04W 36/08; H04W 72/25; H04W 76/20

(52) U.S. Cl. CPC H04W 76/19; H04W 36/08; H04W 72/25; H04W 76/20

(57) ABSTRACT

The present disclosure relates to a 5G or 6G communication system for supporting higher data transmission rates. The present disclosure provides a method related to operation of a repeater controlled by a network in wireless communication system (or a mobile communication system).

### TECHNICAL FIELD

The disclosure relates to a wireless communication system (or mobile communication system). Specifically, the disclosure relates to a method and a device for an operation of a network-controlled repeater in a wireless communication system (or mobile communication system).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### DISCLOSURE OF INVENTION

### Technical Problem

The disclosure provides a method and a device relating to an operation of a network-controlled repeater.

### Solution to Problem

According to an embodiment of the disclosure, a method performed by a network-controlled repeater (NCR) in a wireless communication system may include: performing, by a mobile termination (MT) of the NCR, a radio resource control (RRC) re-establishment procedure; controlling, by the MT of the NCR, a forward (FWD) of the NCR to be in an off state in the RRC re-establishment procedure; receiving side control information (SCI); and controlling the FWD of the NCR to be in an on state, based on the SCI.

The performing, by the MT of the NCR, of the RRC re-establishment procedure may include: releasing preconfigured SCI; and performing cell selection.

The RRC re-establishment procedure may be performed due to occurrence of a radio link failure (RLF).

The method may further include: performing, by the MT of the NCR an RRC idle state transition procedure; and controlling an FWD state of the NCR to be turned off during the RRC idle state transition procedure.

The method may further include: performing a cell reselection procedure; identifying whether a cell selected according to the cell reselection procedure is different from a previous cell; and controlling the FWD of the NCR to be in the off state, based on a result of the identification.

The identifying of whether the cell selected according to the cell reselection procedure is different from the previous cell may include identifying whether the cell selected according to the cell reselection procedure is different from a cell having provided preconfigured SCI.

The method may further include stopping cell signal forwarding, based on the off state of the FWD.

The method may further include starting or resuming cell signal forwarding, based on the on state of the FWD.

According to an embodiment of the disclosure, a network-controlled repeater (NCR) device including a mobile termination (MT) and a forward (FWD) in a wireless communication system may include: a transceiver; and at least one processor coupled to the transceiver, wherein the at least one processor is configured to perform by the mobile termination (MT) of the NCR, a radio resource control (RRC) re-establishment procedure, control, by the MT of the NCR, the forward (FWD) of the NCR device to be in an off state in the RRC re-establishment procedure, receive side control information (SCI), and control the FWD of the NCR device to be in an on state, based on the SCI.

The at least one processor may be configured to release preconfigured SCI and perform cell selection.

The RRC re-establishment procedure may be performed due to occurrence of a radio link failure (RLF).

The at least one processor may be configured to perform, by the MT of the NCR, an RRC idle state transition procedure, and control an FWD state of the NCR device to be turned off during the RRC idle state transition procedure.

The at least one processor may be configured to perform a cell reselection procedure, identify whether a cell selected according to the cell reselection procedure is different from a previous cell, and control the FWD of the NCR device to be in the off state, based on a result of the identification.

The at least one processor may be configured to identify whether the cell selected according to the cell reselection procedure is different from a cell having provided preconfigured SCI.

The at least one processor may be configured to stop cell signal forwarding, based on the off state of the FWD, and start or resume cell signal forwarding, based on the on state of the FWD.

### Advantageous Effects of Invention

According to various embodiments of the disclosure, a device and a method capable of effectively providing services in a mobile communication system can be provided.

### BRIEF DESCRIPTION OF DRAWINGS

FIG. 1 illustrates a structure of a typical LTE system.

FIG. 2 illustrates a radio protocol structure of a typical LTE system;

FIG. 3 illustrates a structure of a next-generation mobile communication system according to an embodiment of the disclosure.

FIG. 4 illustrates a radio protocol structure of a next-generation mobile communication system according to an embodiment of the disclosure.

FIG. 5 is a block diagram illustrating an internal structure of a UE according to an embodiment of the disclosure.

FIG. 6 is a block diagram illustrating a structure of an NR base station according to an embodiment of the disclosure.

FIG. 7 illustrates a method in which an FWD is turned off during a “going to RRC_IDLE” process in a cell selection process of an MT according to an embodiment of the disclosure.

FIG. 8 illustrates a case where an MT turns off an FWD, and then performs a “going to RRC_IDLE” operation, and performs cell selection according to an embodiment of the disclosure.

FIG. 9 illustrates FWD OFF according to a result obtained by performing cell selection by an MT according to an embodiment of the disclosure.

FIG. 10 illustrates an operation in a case of selection of the same cell according to an embodiment of the disclosure.

FIG. 11 illustrates another operation in a case of selection of the same cell according to an embodiment of the disclosure.

FIG. 12 illustrates still another operation in a case of selection of the same cell according to an embodiment of the disclosure.

FIG. 13 illustrates an operation in a case of selection of a different cell according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In describing the disclosure below, a detailed description of relevant known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the base station and the terminal are not limited to the above examples. In the disclosure, a “downlink (DL)” refers to a radio link via which a base station transmits a signal to a terminal, and an “uplink (UL)” refers to a radio link via which a terminal transmits a signal to a base station.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km² ) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. Therefore, for the services supporting URLLC, a 5G system must provide a transmit time interval (TTI) shorter than those of other services, and also may require a design for assigning a large number of resources in a frequency band in order to secure reliability of a communication link.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

Proposed is an operation for resolving a mismatch between an operation of a mobile termination (MT) of a network-controlled repeater and an operation of a forwarding entity, or enabling faster recovery from an OFF state.

The disclosure for solving problems such as a mismatch between an operation of an MT of a network-controlled repeater and an operation of a forwarding entity or faster recovery from an OFF state relates to a method for processing a control signal in a wireless communication system, the method including: receiving a first control signal transmitted from a base station; processing the received first control signal; and transmitting a second control signal generated based on the processing to the base station.

According to an embodiment of the disclosure, a network-controlled repeater may perform an effective predetermined forwarding operation depending on a connection state of an MT.

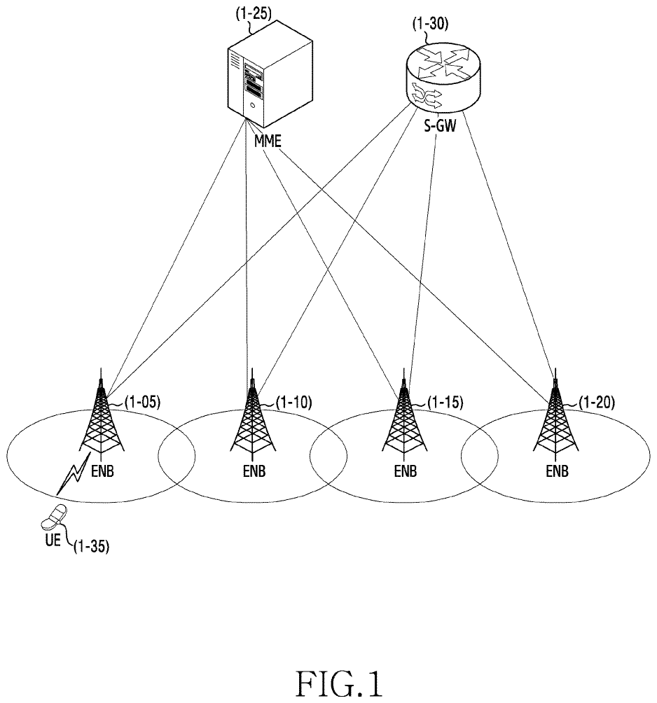

FIG. 1 illustrates a structure of a typical LTE system.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05 to 1-20 and the S-GW 1-30.

In FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over IP (VoIP) via the Internet protocol, may be serviced through a shared channel. Thus, a device that collects state information, such as buffer states, available transmit power states, and channel states of UEs, and performs scheduling accordingly is required, and the ENBs 1-05 to 1-20 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE. The S-GW 1-30 is a device that provides a data bearer, and may generate or remove a data bearer under the control of the MME 1-25. The MME is a device responsible for various control functions as well as a mobility management function for a UE, and may be connected to multiple base stations.

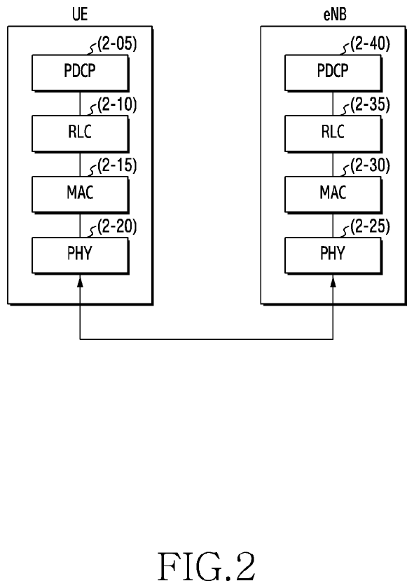

FIG. 2 illustrates a radio protocol structure of a conventional LTE.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 on each of UE and ENB sides. The PDCP may serve to perform operations such as IP header compression/reconstruction. The main functions of the PDCP may be summarized as follows. The PDCP is not limited by the following exemplary functions and may perform various functions.
Header compression and decompression: robust header compression (ROHC) only
Transfer of user data
In-sequence delivery (In-sequence delivery of upper layer PDUs at PDCP re-establishment procedure for RLC AM)
For split bearers in dual connectivity (DC) (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) into an appropriate size to perform an ARQ operation. The main functions of the RLC may be summarized as follows. The RLC is not limited by the following exemplary functions and may perform various functions.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC are summarized as follows. The MAC is not limited by the following exemplary functions and may perform various functions.
Mapping between logical channels and transport channels
Multiplexing/demultiplexing of MAC SDUs belonging to one or different logical channels into/from transport blocks (TB) delivered to/from the physical layer on transport channels
Scheduling information reporting
HARQ (Error correction through HARQ)
Priority handling between logical channels of one UE
Priority handling between UEs by means of dynamic scheduling
Multimedia broadcast and multicast service (MBMS) service identification
Transport format selection
Padding

A physical (PHY) layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The PHY layer is not limited by these exemplary functions and may perform various functions.

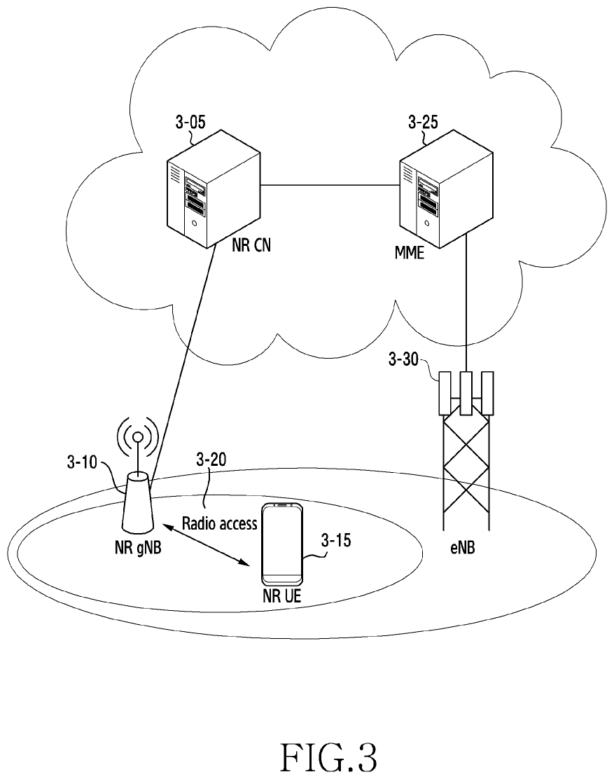

FIG. 3 illustrates a structure of a next-generation mobile communication system according to an embodiment of the disclosure.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved node B (eNB) of a conventional LTE system. The NR gNB 1c-10 may be connected to the NR UE 1c-15 through a radio channel and may provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 3-10 may serve as the device. In general, one NR gNB may control multiple cells. In order to implement ultrahigh-speed data transfer beyond the current LTE, the next-generation mobile communication system may employ a wider bandwidth than the existing maximum bandwidth. In addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 3-05 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN 3-05 may be connected to an MME 3-25 via a network interface. The MME may be connected to an eNB 3-30 that is an LTE base station.

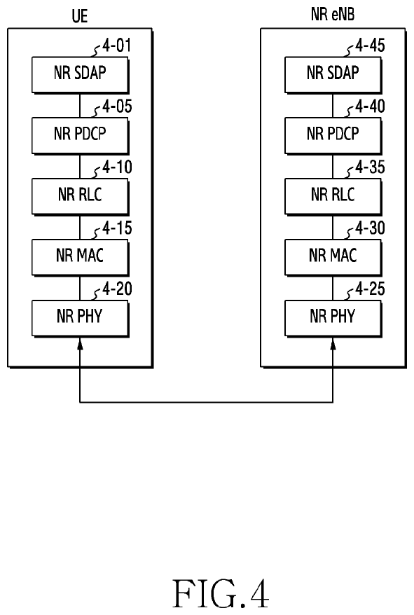

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 on each of UE and NR base station sides.

The main functions of the NR SDAP 4-01 or 4-45 may include some of functions below. The NR SDAP is not limited by the following exemplary functions and may perform various functions.
Transfer of user plane data
Mapping between a QoS flow and a data bearer for uplink and downlink (mapping between a QoS flow and a DRB for both DL and UL)
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 4-05 or 4-40 may include some of functions below. The NR PDCP is not limited by the following exemplary functions and may perform various functions.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device may refer to a function of reordering PDCP PDUs received from a lower layer in an order based on PDCP sequence numbers (SNs). The reordering of the NR PDCP device may include a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

The main functions of the NR RLC 4-10 or 4-35 may include some of functions below. The NR RLC is not limited by the following exemplary functions and may perform various functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may refer to a function of successively delivering RLC SDUs received from the lower layer to the upper layer. If one original RLC SDU is divided into several RLC SDUs and the RLC SDUs are received, the in-sequence delivery function of the NR RLC device may include a function of reassembling the several RLC SDUs and transferring the reassembled RLC SDUS.

The in-sequence delivery of the NR RLC device may include a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

The in-sequence delivery of the NR RLC device may refer to a function of, if there is a lost RLC PDU, delivering only RLC SDUs before the lost RLC PDU to the upper layer in sequence.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to the current, to a higher layer.

The NR RLC device may process RLC PDUs in a reception sequence, regardless of a sequence based on sequence numbers (out-of-sequence delivery), and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include a concatenation function, but the concatenation function may be performed in the NR MAC layer or replaced with a multiplexing function of the NR MAC layer.

The out-of-sequence delivery of the NR RLC device 1035 or 1060 may refer to a function of directly delivering RLC SDUs, received from the lower layer, to the upper layer regardless of the sequence. The out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging order to record lost RLC PDUs.

The NR MAC 14-15 or 4-30 may be connected to multiple NR RLC layer devices configured in one UE, and the main functions of the NR MAC may include some of functions below. The NR MAC is not limited by the following exemplary functions and may perform various functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR physical (PHY) layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The NR PHY layer is not limited by these exemplary functions and may perform various functions.

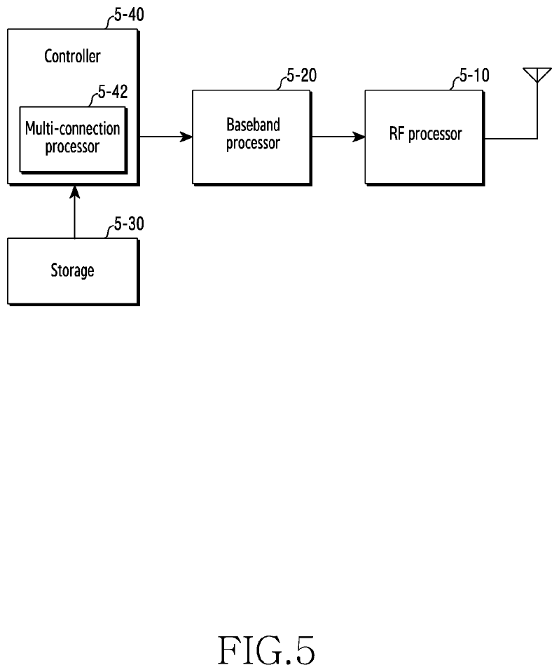

FIG. 5 is a block diagram illustrating an internal structure of a UE according to an embodiment of the disclosure.

Referring to FIG. 5, the UE may include a radio frequency (RF) processor 5-10, a baseband processor 5-20, a storage 5-30, and a controller 5-40. Obviously, the above example is not limiting, and the UE may include a larger or smaller number of components than the components illustrated in FIG. 5.

The RF processor 5-10 may perform a function for transmitting and receiving a signal via a wireless channel, such as band conversion and amplification of the signal. That is, the RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), and the like. Although only one antenna is illustrated in FIG. 5, the UE may include multiple antennas. In addition, the RF processor 5-10 may include multiple RF chains. Furthermore, the RF processor 5-10 may perform beamforming. For the beamforming, the RF processor 5-10 may adjust the phase and magnitude of each of signals transmitted and received through multiple antennas or antenna elements. In addition, the RF processor 5-10 may perform MIMO, and may receive multiple layers when performing MIMO operations.

The baseband processor 5-20 may perform functions of conversion between baseband signals and bitstrings according to the system's physical layer specifications. For example, during data transmission, the baseband processor 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the orthogonal frequency division multiplexing (OFDM) scheme, during data transmission, the baseband processor 5-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

The baseband processor 5-20 and the RF processor 5-10 may transmit and receive signals as described above. Therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GHz) bands. The UE may transmit/receive signals to/from the base station by using the baseband processor 5-20 and the RF processor 5-10. The signals may include control information and data.

The storage 5-30 may store basic programs, application programs, and data, such as configuration information, for operation of the main base station. Particularly, the storage 5-30 may store information regarding a second access node configured to perform wireless communication by using a second radio access technology. In addition, the storage 5-30 may provide the stored data at the request of the controller 5-40.

The controller 5-40 may control the overall operation of the UE. For example, the controller 5-40 may transmit/receive signals through the baseband processor 5-20 and the RF processor 5-10. In addition, the controller 5-40 records data in the storage 5-30 and reads the data from the storage 5-30. To this end, the controller 5-40 may include at least one processor. For example, the controller 5-40 may include a communication processor (CP) configured to perform control for communication, and an application processor (AP) configured to control upper layers such as application programs. The controller 5-40 may further include a multi-connection processor 5-42 to support multiple connections.

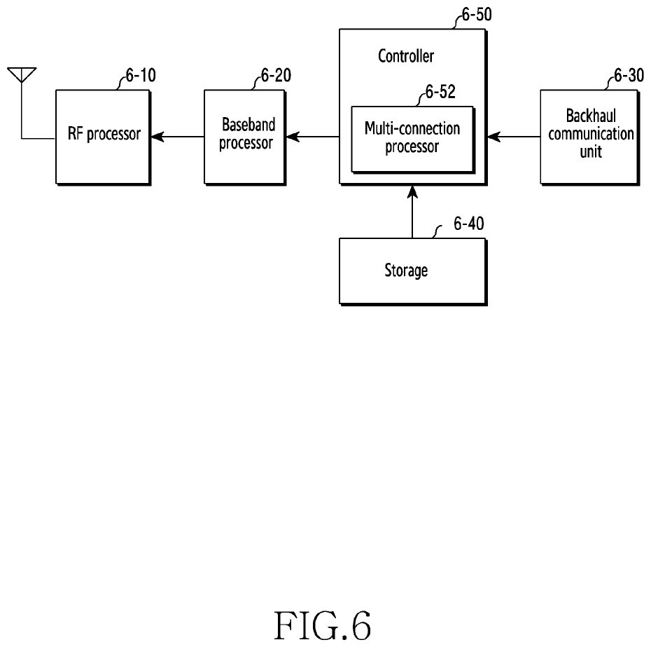

FIG. 6 is a block diagram illustrating a structure of an NR base station according to an embodiment of the disclosure.

Referring to FIG. 6, the base station may include an RF processor 6-10, a baseband processor 6-20, a backhaul communication unit 6-30, a storage 6-40, and a controller 6-50. Obviously, the above example is not limiting, and the base station may include a larger or smaller number of components than the components illustrated in FIG. 6.

The RF processor 6-10 may perform a function for transmitting and receiving a signal via a wireless channel, such as band conversion and amplification of the signal. That is, the RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in FIG. 6, the base station may include multiple antennas. In addition, the RF processor 6-10 may include multiple RF chains. Furthermore, the RF processor 6-10 may perform beamforming. For the beamforming, the RF processor 6-10 may adjust the phase and magnitude of each of signals transmitted and received through multiple antennas or antenna elements. The RF processor 6-10 may transmit one or more layers to perform a downward MIMO operation.

The baseband processor 6-20 may perform functions of conversion between baseband signals and bitstrings according to the physical layer specifications of first radio access technology. For example, during data transmission, the baseband processor 6-20 may encode and modulate a transmitted bitstring to generate complex symbols. In addition, during data reception, the baseband processor 6-20 may demodulate and decode a baseband signal provided from the RF processor 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through an IFFT operation and CP insertion. In addition, during data reception, the baseband processor 6-20 may split a baseband signal provided from the RF processor 6-10 at the OFDM symbol level, may restore signals mapped to subcarriers through FFT operation, and may restore a received bitstring through demodulation and decoding. The baseband processor 6-20 and the RF processor 6-10 may transmit and receive signals as described above. Therefore, the baseband processor 6-20 and the RF processor 6-10 may be referred to as a transmitter, a receiver, a transceiver, a communication unit, or a wireless communication unit. The base station may transmit/receive signals to/from the UE by using the baseband processor 6-20 and the RF processor 6-10. The signals may include control information and data.

The backhaul communication unit 6-30 may provide an interface for performing communication with other nodes within a network. That is, the backhaul communication unit 6-30 may convert bitstrings transmitted from the main base station to other nodes (for example, auxiliary base station, core network) into physical signals, and may convert physical signals received from the other nodes into bitstrings.

The storage 6-40 may store basic programs, application programs, and data, such as configuration information, for operation of the main base station. In particular, the storage 6-40 may store information on bearers allocated to the connected UE, measurement results reported from the connected UE, and the like. In addition, the storage 6-40 may store information serving as a reference to determine whether to provide multi-connection to a UE or to suspend the same. In addition, the storage 6-40 may provide the stored data at the request of the controller 6-50.

The controller 6-50 may control the overall operation of the base station. For example, the controller 6-50 may transmit/receive signals through the baseband processor 6-20 and the RF processor 6-10 or through the backhaul communication unit 6-30. In addition, the controller 6-50 records data in the storage 6-40 and reads the data from the storage 6-40. To this end, the controller 6-50 may include at least one processor. In addition, the controller 6-50 may further include a multi-connection processor 6-52 to support multiple connections.

Hereinafter, a technique related to the following is proposed.
1. An operation of a forwarding entity (FWD) related to cell selection
2. An operation of the FWD upon expiration of a timing advance timer
3. An operation of the FWD in an RRC reestablishment state

Here, an ON operation of the FWD refers to an operation of receiving an RF signal of a serving cell through a beam of a backhaul link, amplifying the signal, and transmitting the signal through a beam of an access link, and an operation of receiving an RF signal from a UE through a beam on an access link, amplifying the signal, and transmitting the signal to a serving cell through a beam on a backhaul link.

Accordingly, OFF of the FWD corresponds to at least one of the following.
An RF signal of a serving cell is not received through a beam of a backhaul link.
The RF signal of the serving cell, received through the beam of the backhaul link, is not transmitted through a beam of an access link.
The RF signal is not received from a UE through the beam on the access link.
The RF signal of the serving cell, received through the beam of the backhaul link, is not transmitted to the serving cell through the beam of the backhaul link.

First, 1. An operation of an FWD related to cell selection is described.

When an NCR MT performs cell selection, a control link (C-link) of an MT of an NCR node does not exist. Further, even the selected cell may be a cell different from a cell in a previous connection state. Accordingly, a mismatch may occur in the operation of the FWD, which has used a C-link beam as a backhaul link beam in a connection mode of the MT.

In such a case, an NCR-FWD may perform an OFF operation or an ON operation with respect to a cell selection operation of the MT. If a previous operation was in an ON state of the FWD, the FWD may be turned OFF.

In a more detailed situation, since the cell selection operation of the MT is included at the end of a “going to RRC_IDLE” operation of the MT, FWD OFF may be included in the “going to RRC_IDLE” operation as solution 1.

In an embodiment, the operation may be as follows. That is, before the MT performs cell selection, the MT may indicate the FWD to be turned OFF, or the FWD may be implicitly turned OFF before the cell selection operation without such an indication. In addition, during this process, side control information (SCI) of the FWD may be released or kept. If it is intended to operate the FWD in an idle mode of the MT, that is, if it is intended to keep the FWD, as shown in a blue part of the embodiment below, only a part other than an SCI configuration of the FWD may be released in a radio resource release operation of the MT.

### 5.3.11 UE Actions Upon Going to RRC_IDLE

The UE shall:

1> reset MAC;

1> set the variable pendingRNA-Update to false, if that is set to true;

1> if going to RRC_IDLE was triggered by reception of the RRCRelease message including a waitTime:

2> if T302 is running:

3> stop timer T302;

2> start timer T302 with the value set to the waitTime;

2> inform upper layers that access barring is applicable for all access categories except categories ‘0’ and ‘2’.

1> else:

2> if T302 is running:

3> stop timer T302;

3> perform the actions as specified in 5.3.14.4;

1> if T390 is running:

2> stop timer T390 for all access categories;

2> perform the actions as specified in 5.3.14.4;

1> if the UE is leaving RRC_INACTIVE:

2> if going to RRC_IDLE was not triggered by reception of the RRCRelease message:

3> if stored, discard the cell reselection priority information provided by the cellReselectionPriorities;

3> stop the timer T320, if running;

1> stop all timers that are running except T302, T320, T325, T330, T331 and T400;

1> discard the UE Inactive AS context, if any;

1> release the suspendConfig, if configured;

1> remove all the entries within the MCG and the SCG VarConditionalReconfig, if any;

1> for each measId, if the associated reportConfig has a reportType set to condTriggerConfig:

2> for the associated reportConfigId:

3> remove the entry with the matching reportConfigId from the reportConfigList within the VarMeasConfig;

2> if the associated measObjectId is only associated to a reportConfig with reportType set to condTriggerConfig:

3> remove the entry with the matching measObjectId from the measObjectList within the VarMeasConfig;

2> remove the entry with the matching measId from the measIdList within the VarMeasConfig;

1> discard the K_{gNB} key, the S-K_{gNB} key, the S-K_{eNB} key, the K_{RRCenc} key, the K_{RRCint} key, the K_{UPint} key and the K_{UPenc} key, if any;

1> release all radio resources (except FWD SCI configuration for NCR-MT), including release of the RLC entity, the BAP entity, the MAC configuration and the associated PDCP entity and SDAP for all established RBs (except for broadcast MRBs), BH RLC channels, Uu Relay RLC channels, PC5 Relay RLC channels and SRAP entity;

1> indicate the release of the RRC connection to upper layers together with the release cause;

1> inform upper layers about the release of all application layer measurement configurations;

1> discard any application layer measurement reports which were not yet submitted to lower layers for transmission;

1> discard any segments of segmented RRC messages stored according to 5.7.6.3;

1> except if going to RRC_IDLE was triggered by inter-RAT cell reselection while the UE is in RRC_INACTIVE or RRC_IDLE or when selecting an inter-RAT cell while T311 was running or when selecting an E-UTRA cell for EPS fallback for IMS voice as specified in 5.4.3.5:

2> if UE is NCR-MT, MT indicates to FWD of FWD-OFF or, if UE is NCR-MT, FWD goes OFF, if FWD was ON before

2> enter RRC_IDLE and perform cell selection as specified in TS 38.304 [20];

An operation of turning off an FWD or an operation of releasing or keeping SCI configuration information of the FWD may be included in any part of such a section.

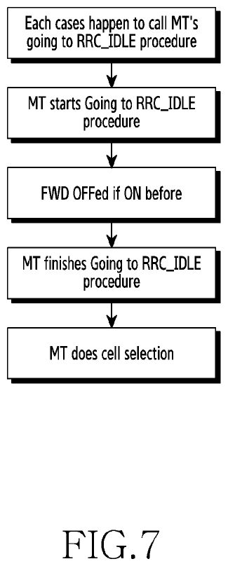

FIG. 7 illustrates a method in which an FWD is turned off during a “going to RRC_IDLE” process in a cell selection process of an MT according to an embodiment of the disclosure.

Referring to FIG. 7, an MT performs a “going to RRC_IDLE” operation. During the operation, the MT may turn off an FWD. After performing the “going to RRC_IDLE” operation, the MT may perform a cell selection operation.

As another method, an FWD OFF operation may be performed during an operation of invoking the “going to RRC_IDLE” operation of the MT. The operation of invoking the “going to RRC_IDLE” operation of the MT is as follows.

Case 1) Upper layer cannot support the paging cause: That is, when the MT has received a paging message from a network in an idle/inactive state, an upper layer (or NAS layer) does not support a paging cause of the paging message.

Case 1.5) cell reselection during T300 or T302 running: That is, when the MT attempts a connection setup in an idle state, and cell reselection occurs during the process.

Case 2) AS security is not activated upon HO execution: When an RRCReconfiguration includes a reconfiguration WithSync field, and AS security is not activated when the corresponding RRCReconfiguration is applied.

Case 3) Reconfiguration failure on AS security has been setup, but not SRB2 setup.: When an RRCReconfiguration is applied, AS security has been set up, but SRB2 has not been set up.

Case 4) Upon reception of RRE, integrity protection check fails: When an RRCReestablishment message is received from the network, but an integrity protection verification procedure fails.

Case 5) T311 expiry:

Case 6) T301 expiry

Case 7) Data inactivity timer expiry

Case 8) RRCrelease requested by upper layer (NAS)

Case 9) Upon receiving RRCRelease or RRCRelease with suspendConfig msg.

When operations of invoking the “going to RRC_IDLE” operation of the MT occur, the MT may transmit an OFF indicator to the FWD before the “going to RRC_IDLE” operation of the MT, or the FWD may turn itself OFF.

The following examples illustrate an order in which FWD OFF may be performed for each case.

In a specific embodiment, in relation to one manner, in the case of case 1 below, the FWD Off operation may be executed before the “going to RRC_IDLE” operation. However, the following embodiment is not the only valid embodiment, and the FWD Off operation may be performed in any order within the operations of case 1 below.

Upon receiving the Paging message by the UE, the UE shall:

1> if in RRC_INACTIVE, for each of the PagingRecord, if any, included in the Paging message

2> if the ue-Identity included in the PagingRecord matches the UE's stored fullI-RNTI:

2> else if the ue-Identity included in the PagingRecord matches the UE identity allocated by upper layers:

3> if upper layers indicate the support of paging cause:

4> forward the ue-Identity, accessType (if present) and paging cause (if determined) to the upper layers;

3> else:

4> forward the ue-Identity and accessType (if present) to the upper layers;

3> if UE is NCR-MT, MT indicates to FWD of FWD-OFF or, if UE is NCR-MT, FWD goes OFF, if FWD was ON before

3> perform the actions upon going to RRC_IDLE as specified in 5.3.11 with release cause ‘other’;

In the case of case 1.5, the FWD Off operation may be executed before the “going to RRC_IDLE” operation, as shown below. However, the following embodiment is not the only valid embodiment, and the FWD Off operation may be performed in any order within the operations of case 1.5 below.

The UE shall:

1> if cell reselection occurs while T300 or T302 is running; or

1> if relay reselection occurs while T300 is running; or

1> if cell changes due to relay reselection while T302 is running:

2> if UE is NCR-MT, MT indicates to FWD of FWD-OFF or, if UE is NCR-MT, FWD goes OFF, if FWD was ON before

2> perform the actions upon going to RRC_IDLE as specified in 5.3.11 with release cause ‘RRC connection failure’;

Case 2 is an example of a case where the MT applies an RRCReconfiguration including a reconfigurationWithSync field. The FWD Off operation may be executed before the “going to RRC_IDLE” operation, as shown below. However, the following embodiment is not the only valid embodiment, and the FWD Off operation may be performed in any order within the operations of case 2 below.

### 5.3.5.5.2 Reconfiguration with Sync

The UE shall perform the following actions to execute a reconfiguration with sync.

1> stop timer T430 if running;

1> start timer T430 with the timer value set to ntn-U1Sync Validity Duration from the subframe indicated by epochTime, if included in the reconfiguration WithSync for serving cell;

1> if the AS security is not activated,

2> if UE is NCR-MT, MT indicates to FWD of FWD-OFF or, if UE is NCR-MT, FWD goes OFF, if FWD was ON before

2> perform the actions upon going to RRC_IDLE as specified in 5.3.11 with the release cause ‘other’ upon which the procedure ends;

In the case of case 3, when the MT receives an RRCReconfiguration and fails to pass the compliance check of the corresponding configuration, that is, the MT is unable to comply with the received RRCReconfiguration, the MT may perform FWD OFF before going to RRC_IDLE.

### 5.3.5.8 Reconfiguration Failure

### 5.3.5.8.1 Void

5.3.5.8.2 Inability to Comply with RRCReconfiguration

<omitted>

2> else if the UE is unable to comply with (part of) the configuration included in the RRCReconfiguration message received over the SRB1 or if the upper layers indicate that the nas-Container is invalid:

NOTE 0a: The compliance also covers the SCG configuration carried within octet strings e.g. field mrdc-Secondary CellGroupConfig. I.e. the failure behaviour defined also applies in case the UE cannot comply with the embedded SCG configuration or with the combination of (parts of) the MCG and SCG configurations.

NOTE 0b: The compliance also covers the V2X sidelink configuration carried within an octet string, e.g. field sl-ConfigDedicatedEUTRA. I.e. the failure behaviour defined also applies in case the UE cannot comply with the embedded V2X sidelink configuration.

3> if the RRCReconfiguration message was received as part of ConditionalReconfiguration:

4> continue using the configuration used prior to when the inability to comply with the RRCReconfiguration message was detected;

3> else:

4> continue using the configuration used prior to the reception of RRCReconfiguration message;

3> if AS security has not been activated:

4> if UE is NCR-MT, MT indicates to FWD of FWD-OFF or, if UE is NCR-MT, FWD goes OFF, if FWD was ON before

4> perform the actions upon going to RRC_IDLE as specified in 5.3.11, with release cause ‘other’

3> else if AS security has been activated but SRB2 and at least one DRB or multicast MRB or, for IAB, SRB2, have not been setup:

4> if UE is NCR-MT, MT indicates to FWD of FWD-OFF or, if UE is NCR-MT, FWD goes OFF, if FWD was ON before

4> perform the actions upon going to RRC_IDLE as specified in 5.3.11, with release cause ‘RRC connection failure’;

In the case of case 4, when the MT receives an RRCReestablishment and then fails the integrity protection check of the RRCReestablishment message in an application step, the MT may perform FWD OFF before the “going to RRC_IDLE” operation.

### 5.3.7.5 Reception of the RRCReestablishment by the UE

The UE shall:

1> stop timer T301;

1> consider the current cell to be the PCell;

1> update the K_{gNB} key based on the current K_{gNB} key or the NH, using the received nextHopChainingCount value, as specified in TS 33.501 [11];

1> store the nextHopChainingCount value indicated in the RRCReestablishment message;

1> derive the K_{RRCenc} and K_{UPenc} keys associated with the previously configured cipheringAlgorithm, as specified in TS 33.501 [11];

1> derive the K_{RRCint} and K_{UPint} keys associated with the previously configured integrityProtAlgorithm, as specified in TS 33.501 [11].

1> request lower layers to verify the integrity protection of the RRCReestablishment message, using the previously configured algorithm and the K_{RRCint} key;

1> if the integrity protection check of the RRCReestablishment message fails:

2> if UE is NCR-MT, MT indicates to FWD of FWD-OFF or, if UE is NCR-MT, FWD goes OFF, if FWD was ON before

2> perform the actions upon going to RRC_IDLE as specified in 5.3.11, with release cause ‘RRC connection failure’, upon which the procedure ends;

In the case of cases 5 and 6, when T311 expires or T301 expires, the MT may perform FWD OFF before performing going to RRC_IDLE.

### 5.3.7.6 T311 Expiry

Upon T311 expiry, the UE shall:

1> if the procedure was initiated due to radio link failure or handover failure:

2> set the noSuitableCellFound in the VarRLF-Report to true;

1> if UE is NCR-MT, MT indicates to FWD of FWD-OFF or, if UE is NCR-MT, FWD goes OFF, if FWD was ON before

1> perform the actions upon going to RRC_IDLE as specified in 5.3.11, with release cause ‘RRC connection failure’.

### 5.3.7.7 T301 Expiry or Selected Cell/L2 U2N Relay UU no Longer Suitable

The UE shall:

1> if timer T301 expires; or

1> if the selected cell becomes no longer suitable according to the cell selection criteria as specified in TS 38.304 [20]; or

1> if the (re)selected L2 U2N Relay UE becomes unsuitable; or

1> upon reception of NotificationMessageSidelink indicating relayUE-HO or relayUE-CellReselection:

2> if UE is NCR-MT, MT indicates to FWD of FWD-OFF or, if UE is NCR-MT, FWD goes OFF, if FWD was ON before

2> perform the actions upon going to RRC_IDLE as specified in 5.3.11, with release cause ‘RRC connection failure’.

In the case of case 8, when the MT receives an RRCRelease message, FWD OFF may be performed before performing going to RRC_IDLE.

### 5.3.8.3 Reception of the RRCRelease by the UE

The UE shall:

1> delay the following actions defined in this clause 60 ms from the moment the RRCRelease message was received or optionally when lower layers indicate that the receipt of the RRCRelease message has been successfully acknowledged, whichever is earlier;

1> stop timer T380, if running;

1> stop timer T320, if running;

1> if timer T316 is running;

2> stop timer T316;

2> clear the information included in VarRLF-Report, if any;

1> stop timer T350, if running;

1> stop timer T346g, if running;

1> if the AS security is not activated:

2> ignore any field included in RRCRelease message except waitTime;

2> if UE is NCR-MT, MT indicates to FWD of FWD-OFF or, if UE is NCR-MT, FWD goes OFF, if FWD was ON before

2> perform the actions upon going to RRC_IDLE as specified in 5.3.11 with the release cause ‘other’ upon which the procedure ends;

In relation to a data inactivity timer, when the timer expires, the MT may turn off the FWD before the “going to RRC_IDLE” operation.

### 5.3.8.5 UE Actions Upon the Expiry of DataInactivity Timer

Upon receiving the expiry of DataInactivity Timer from lower layers while in RRC CONNECTED, the UE shall:

1> if UE is NCR-MT, MT indicates to FWD of FWD-OFF or, if UE is NCR-MT, FWD goes OFF, if FWD was ON before

1> perform the actions upon going to RRC_IDLE as specified in 5.3.11, with release cause ‘RRC connection failure’.

When the MT receives an RRC Release request from an upper layer, the FWD may be turned OFF before going to RRC_IDLE.

### 5.3.9 RRC Connection Release Requested by Upper Layers

### 5.3.9.1 General

The purpose of this procedure is to release the RRC connection. Access to the current PCell may be barred as a result of this procedure.

### 5.3.9.2 Initiation

The UE initiates the procedure when upper layers request the release of the RRC connection as specified in TS 24.501 [23]. The UE shall not initiate the procedure for power saving purposes.

The UE shall:

1> if the upper layers indicate barring of the PCell:

2> treat the PCell used prior to entering RRC_IDLE as barred according to TS 38.304 [20];

1> if UE is NCR-MT, MT indicates to FWD of FWD-OFF or, if UE is NCR-MT, FWD goes OFF, if FWD was ON before

1> perform the actions upon going to RRC_IDLE as specified in 5.3.11, with release cause ‘other’.

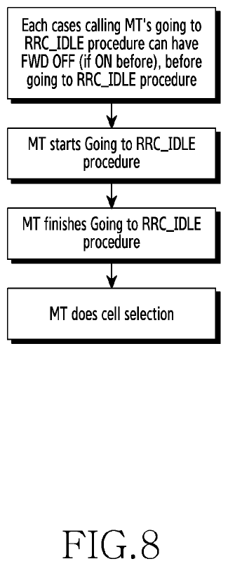

FIG. 8 illustrates a case where an MT turns off an FWD, and then performs a “going to RRC_IDLE” operation, and performs cell selection according to an embodiment of the disclosure.

While the described embodiments illustrate a method of performing FWD OFF before a cell selection process of an MT, in another embodiment, when the MT performs cell selection and a result of the cell selection indicates that a cell different from a cell in a previous connection mode state is selected, an FWD OFF operation may be performed. In this case, the MT may include, in an RRCRelease or RRCRelease with suspendConfig message received by the MT, an indicator indicating to perform such an operation, that is, perform FWD OFF when the result of the cell selection indicates a cell different from a serving cell in a previous connection mode. In addition, the serving cell in the previous connection mode may be defined as the most recent cell having provided NCR FWD SCI in the previous connection mode.

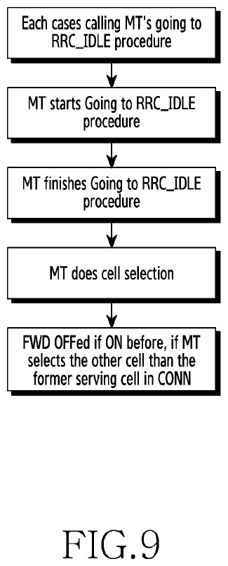

FIG. 9 illustrates FWD OFF according to a result obtained by performing cell selection by an MT according to an embodiment of the disclosure.

In this case, an MT may perform a corresponding procedure for each case, perform going to RRC_IDLE, and perform cell selection at the end. When a selected cell is different from a serving cell in a previous connection mode of the MT, or from the serving cell having provided SCI in the previous connection mode, an FWD may be turned OFF.

When a cell different from the serving cell is selected, an SCI configuration of the FWD may be released together with radio resource configuration information in the “going to RRC_IDLE” operation of the MT, may be released only when a cell different from the previously connected cell is selected after cell selection, or may be cleared at a time point when the MT performs a resume or connection setup to a different gNB after cell selection and receives new SCI.

The operation may be performed by including a separate indicator in an RRCReconfiguration or RRCRelease message and transmitting the message to the MT.

### 2. MT Operation in Case of TAT Expiry

A timing advance timer is used after a UE has obtained TA information, and a specific period of time has elapsed, to re-acquire TA and report the TA to the network if necessary. When the TAT expires, assuming that UL TA is not satisfied, in the case of an NCR, it may be considered a state similar to a failure on a C-link of the MT.

Accordingly, when the TAT timer expires in the MT, the MT may turn off the FWD if the FWD was previously ON. The following options are available as a signal for this purpose.

MAC indicate to RRC (upper layer) of TAT expiry and/or FWD OFF, then RRC of MT indicate to FWD to be OFFed, or

MAC indicates to FWD of OFF and/or TAT expiry, and FWD itself can be OFFed, or

when TAT is expired, FWD is OFF.

If the TAT expires and the FWD is turned OFF, the following operations are proposed to turn the FWD on again.

### Opt 1

(implicitly): after RACH procedure successfully completed, i.e., msg2 or 4 is successfully received, or new UL grant included in PDCCH scrambled with C-RNTI is received etc., that is, when an RACH triggered by the TAT is successfully completed, the FWD may be turned ON.

### Opt 2:

(explicitly) when random access procedure triggered due to TAT timer expiry, upon RACH done successfully, MAC indicates RACH success to upper layer (RRC) and/or FWD ON, that is, when an RACH triggered by the TAT succeeds, the MAC of the MT may transmit the RACH success and/or FWD ON indication to the RRC. Further, the RRC of the MT may indicate the FWD to be turned ON. Alternatively, when the RACH succeeds, the MAC of the MT may indicate RACH success and/or FWD ON to the FWD.

As an additional method, when the timing advance timer (TAT) restarts after the TAT has expired, or when a TA value is newly obtained after the TAT has expired, the FWD may be turned ON, or the MAC may indicate the FWD to perform forwarding ON.

In the case of FWD off due to TAT expiry, or FWD off and on, the SCI configuration of the FWD may be maintained or released. The following operations relating thereto are possible.

The MT may maintain the current SCI until the MT receives the next SCI configuration information from the network.

Alternatively, the SCI may be released together when the FWD is turned off due to TAT expiry.

Next, an operation in the MAC when the FWD is turned OFF due to TAT expiry is proposed. The operation indicated in green represents an additional operation which may be performed by the MAC of the MT. That is, when the TAT expires, the MT may notify the RRC of FWD OFF, notify the RRC of TAT expiry, notify the RRC of both FWD OFF and TAT expiry, or directly indicate the FWD itself to be turned OFF. This operation may be performed in any order during the following TAT expiry procedure.

### TS 38.321

1> when a timeAlignmentTimer expires:

2> if the timeAlignmentTimer is associated with the PTAG:

3> flush all HARQ buffers for all Serving Cells;

3> notify RRC to release PUCCH for all Serving Cells, if configured;

3> notify RRC to release SRS for all Serving Cells, if configured;

3> notify RRC to FWD OFF or notify RRC to TAT expiry and/or FWD OFF or FWD goes to OFF

3> clear any configured downlink assignments and configured uplink grants;

3> clear any PUSCH resource for semi-persistent CSI reporting;

3> consider all running timeAlignmentTimers as expired;

3> maintain NTA (defined in TS 38.211 [8]) of all TAGs.

2> else if the timeAlignmentTimer is associated with an STAG, then for all Serving Cells belonging to this TAG:

3> flush all HARQ buffers;

3> notify RRC to release PUCCH, if configured;

3> notify RRC to release SRS, if configured;

3> clear any configured downlink assignments and configured uplink grants;

3> clear any PUSCH resource for semi-persistent CSI reporting;

3> maintain NTA (defined in TS 38.211 [8]) of this TAG.

### 3. Improvement of an RRC Reestablishment Operation

The existing RRC reestablishment operation of the UE is performed in the following order.

upon initiating RRE,

MT stop most of running timers,

reset MAC, release spcellConfig,

suspend all RBs,

release MCG SCell, MRDC release,

release OtherConfig parameters,

release misc configs,

cell selection.

Apply the default L1 parameters in PHY spec except SIB1, (there is no beam specific configuration to MT, i.e., C-link cannot be setup)

Apply the default MAC Cell Gropu configurations

Apply CCCH config

Apply timeAlignmentTimerCommon in SIB1;

Tx of RREReq. (cause, UE id)

Rx of RRE (store NCC, derive security keys, and release each gap config including MG, MUSIM, FR2 UL)

Tx of RREComplete

After transmitting an RRCReestablishmentRequest, receiving an RRCReestablishment, and transmitting an RRCReestablishmentComplete message, until the UE thereafter receives an RRCReconfiguration message, in relation to a physical layer configuration, the UE performs transmission and reception by using basic configuration information, rather than optimized configuration information for the UE. When the UE is an NCR-MT, this process does not include beam configuration information of a C-link. Accordingly, the C-link is not optimized.

If “cell selection” of a different cell is performed, an additional backhaul beam selection process is required. Therefore, since the current RRE message does not include an operation of configuring a C-link beam by the RRC, an NCR operation is possible only after receiving the RRCReconfiguration message.

However, if selection of the same cell is performed, a backhaul beam-related configuration remains valid (unless the SCI has been previously cleared), and accordingly, an FWD ON operation may be performed for each of the following cases.

### Opt 1.

When selection of the same cell (e.g., a cell where an RLF has occurred, or a serving cell or pcell where an RRC reestablishment procedure or cell selection procedure has started) is performed, FWD ON is performed by reusing SCI received in the previous connection mode (the MT operates on its own).

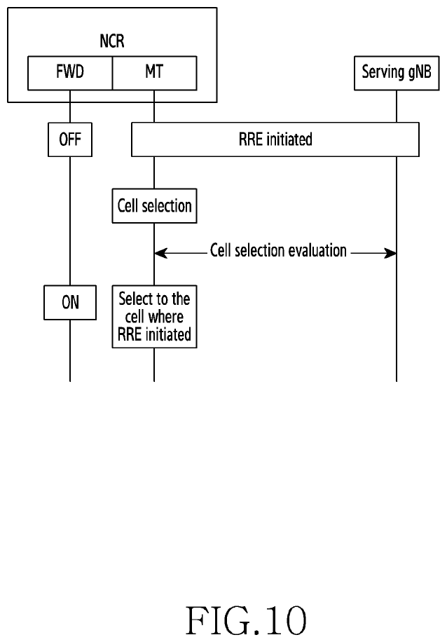

FIG. 10 illustrates an operation in a case of selection of the same cell according to an embodiment of the disclosure.

When an RRC reestablishment procedure starts, an MT may turn OFF an FWD. At the same time, the MT may perform cell selection. When a selected cell is a cell having provided SCI in a previous connection mode, the FWD may be turned ON again. An FWD configuration used in this case may use SCI configuration information used in the previous connection mode.

### Opt 2.

When selection of the same cell (e.g., a cell where an RLF has occurred, or a serving spcell where an RRC reestablishment procedure has started) is performed, an access link beam configuration received in a connection mode of the corresponding cell may be reused. However, after the network transmits a backhaul beam configuration (fresh beam configuration) (that is, in the first RRCReconfiguration message), FWD ON is possible.

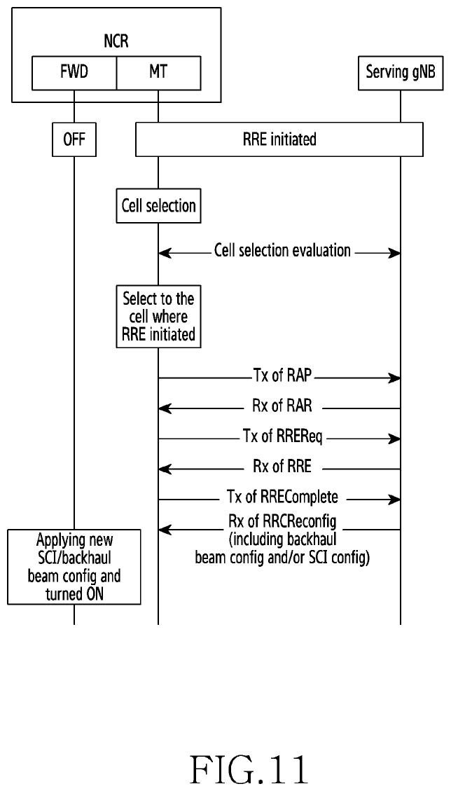

FIG. 11 illustrates another operation in a case of selection of the same cell according to an embodiment of the disclosure.

When an MT RRCReestablishment procedure starts, an FWD may be turned OFF. Thereafter, when cell selection is performed and a serving cell in a previous connection mode is selected, an RA preamble may be transmitted to the serving cell, an RAR may be received from the serving cell, and thus UL grant and TA may be obtained, an RRC reestablishment Request message may be transmitted in msg 3, and an RRCReestablishment message may be received from the serving cell. After the corresponding message information is applied and default physical layer configuration information is applied, an RRCReestablishmentComplete message may be transmitted to the serving cell. Thereafter, in an RRCReconfiguration message, a C-link beam and/or a backhaul link beam of an NCR MT and/or access link beam configuration information (SCI) of an NCR may be received. By applying such information in the message, the FWD may be turned ON.

### Opt 3.

When selection of the same cell (e.g., a cell where an RLF has occurred, or a serving spcell where an RRC reestablishment procedure has started) is performed, an RRE message itself may include information on a beam to be used on a C-link and/or backhaul link (semi-static/adaptive beam indications with corresponding time resource configuration). In this case, instead of an explicit beam indication, a 1-bit indicator indicating the reuse of the backhaul and/or access link beams known from the latest SCI prior to an RRE may be included. In addition, the RRE may further include an access link beam configuration.

Compared to the above, where 1-bit indication or beam information is explicitly displayed in the RRE, the MT may recognize a result of cell selection on its own and, upon receiving the RRCReestablishment message, may reuse a previous FWD configuration and indicate the FWD to be turned ON, or the FWD may turn on by itself.

As an additional embodiment, slightly different from the above case, the FWD may be turned ON at a time point when an RRE complete message is transmitted to a serving base station after receiving the RRE message.

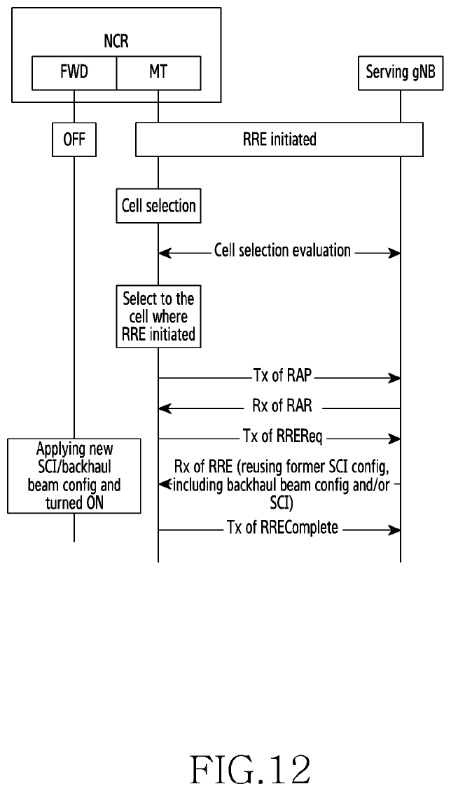

FIG. 12 illustrates still another operation in a case of selection of the same cell according to an embodiment of the disclosure.

When an MT RRCReestablishment procedure starts, an FWD may be turned OFF. Thereafter, when cell selection is performed and a serving cell in a previous connection mode is selected, an RA preamble may be transmitted to the serving cell, an RAR may be received from the serving cell, and thus UL grant and TA may be obtained, an RRC reestablishment Request message may be transmitted in msg 3, and an RRCReestablishment message may be received from the serving cell. In this case, in the corresponding message, a C-link beam and/or a backhaul link beam of an NCR MT and/or access link beam configuration information (SCI) of an NCR may be received. By applying such information in the message, the FWD may be turned ON.

After applying such information, the MT may transmit an RRCReestablishmentComplete message to the serving cell.

### Opt 4.

When selection of a different cell is performed, the FWD is turned OFF, and an FWD ON operation is performed after receiving SCI in an RRCReconfiguration message.

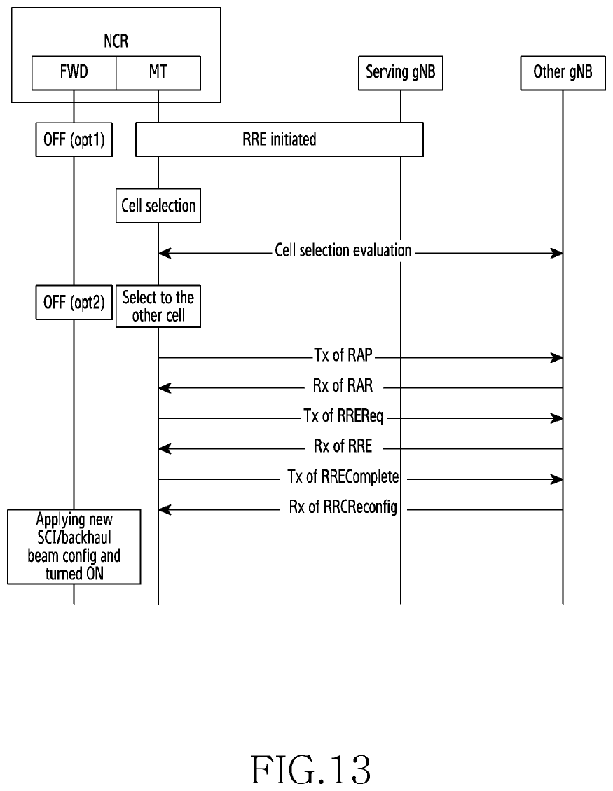

FIG. 13 illustrates an operation in a case of selection of a different cell according to an embodiment of the disclosure.

When an MT RRCReestablishment procedure starts, an FWD may be turned OFF. Alternatively, when cell selection is performed and a cell different from a serving cell in a previous connection mode is selected, the FWD may be turned OFF. When an MT selects a different cell, an RA preamble may be transmitted to the serving cell, an RAR may be received from the serving cell, and thus UL grant and TA may be obtained, an RRC reestablishment Request message may be transmitted in msg 3, and an RRCReestablishment message may be received from the serving cell. After the corresponding message information is applied and default physical layer configuration information is applied, an RRCReestablishmentComplete message may be transmitted to the serving cell. Thereafter, in an RRCReconfiguration message, a C-link beam and/or a backhaul link beam of an NCR MT and/or access link beam configuration information (SCI) of an NCR may be received. By applying such information in the message, the FWD may be turned ON.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a network-controlled repeater (NCR) in a wireless communication system, the method comprising:
performing, by a mobile termination (MT) of the NCR, a radio resource control (RRC) re-establishment procedure;
controlling, by a forwarding unit (FWD) of the NCR to be in an off state during the RRC re-establishment procedure;
receiving, by the MT of the NCR, side control information (SCI), after the RRC re-establishment procedure; and
controlling, by the FWD of the NCR, to be in an on state, based on the SCI.

17. The method of claim 16, wherein the performing, by the MT of the NCR, of the RRC re-establishment procedure comprises:
releasing pre-configured SCI; and
performing a cell selection procedure.

18. The method of claim 16, wherein the RRC re-establishment procedure is performed in case that a radio link failure (RLF) is detected.

19. The method of claim 16, further comprising:
performing, by the MT of the NCR, an RRC idle state transition procedure; and
controlling, by the FWD of the NCR, to be in an off state.

20. The method of claim 16, further comprising:
performing, by the MT of the NCR, a cell reselection procedure;
identifying whether a cell selected based on the cell reselection procedure is different from a previous cell; and
controlling, by the FWD of the NCR, to be in an off state, based on a result of the identification.

21. The method of claim 20, wherein the identifying of whether the cell selected based on the cell reselection procedure is different from the previous cell comprises identifying whether the cell selected based on the cell reselection procedure is different from a cell which has provided pre-configured SCI.

22. The method of claim 16, further comprising ceasing cell signal forwarding, based on an off state of the FWD.

23. The method of claim 16, further comprising starting or resuming cell signal forwarding, based on an on state of the FWD.

24. A network-controlled repeater (NCR) comprising a mobile termination (MT) and a forwarding unit (FWD) in a wireless communication system, the NCR device comprising:
a transceiver; and
at least one processor coupled to the transceiver,
wherein the at least one processor is configured to:
perform, by the MT of the NCR, a radio resource control (RRC) re-establishment procedure;
control, by the FWD of the NCR, to be in an off state during the RRC re-establishment procedure;
receive, by the MT of the NCR, side control information (SCI), after the RRC re-establishment procedure; and
control, by the FWD of the NCR, to be in an on state, based on the SCI.

25. The NCR of claim 24, wherein the at least one processor is configured to:
release pre-configured SCI; and
perform a cell selection procedure.

26. The NCR of claim 24, wherein the RRC re-establishment procedure is performed in case that a radio link failure (RLF) is detected.

27. The NCR of claim 24, wherein the at least one processor is configured to:
perform, by the MT of the NCR, an RRC idle state transition procedure; and
control, by the FWD of the NCR to be in an off state.

28. The NCR of claim 24, wherein the at least one processor is configured to:
perform, by the MT of the NCR, a cell reselection procedure;
identify whether a cell selected based on the cell reselection procedure is different from a previous cell; and
control, by the FWD of the NCR to be in an off state, based on a result of the identification.

29. The NCR of claim 28, wherein the at least one processor is configured to identify whether the cell selected based on the cell reselection procedure is different from a cell which has provided pre-configured SCI.

30. The NCR of claim 24, wherein the at least one processor is configured to:
cease cell signal forwarding, based on an off state of the FWD; and
start or resume cell signal forwarding, based on an on state of the FWD.
